(19) United States
(12) Patent Application Publication
(10) Pub. No.: US 2008/0005108 A1
(43) Pub. Date: Jan. 3, 2008

(54) MESSAGE MINING TO ENHANCE RANKING OF DOCUMENTS FOR RETRIEVAL

(75) Inventors: Raymond E. Ozzie, Seattle, WA (US); Joshua T. Goodman, Redmond, WA (US); Oliver Hurst-Hiller, New York, NY (US); John C. Platt, Bellevue, WA (US); Eric J. Horvitz, Kirkland, WA (US); Eric D. Brill, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/427,314

(22) Filed: Jun. 28, 2006

(51) Int. Cl. G06F 7/00

(52) U.S. Cl. 707/7

(57) ABSTRACT

An architecture is provided for data mining of electronic messages to extract information relating to relevancy and popularity of websites and/or web pages for ranking of web pages or other documents. A monitor component monitors information of a message for a reference to a web page or other document, and a ranking component computes rank of the web page based in part on the reference.

### BACKGROUND

The advent of the Internet has made available to the masses enormous amounts of information which play an increasingly important role in the lives of individuals and companies. For example, the Internet has transformed how goods and services are bought and sold between consumers, between businesses and consumers, and between businesses.

A basic premise is that information affects performance, that is, performance not only in terms of employee productivity but also for the bottom-line performance of companies. Accordingly, failure to provide correct and relevant information to the right person can affect sales. In one example, accurate, timely, and relevant information saves transportation agencies both time and money through increased efficiency, improved productivity, and rapid deployment of innovations. In the realm of large government agencies, access to research results allows one agency to benefit from the experiences of other agencies and to avoid costly duplication of effort. Thus, more efficient and effective access to the data stored on systems can be crucial in aligning corporate strategies with greater business goals.

Given the potential economic return that can be realized for companies that do business over such networks, it becomes important to find means for not only getting information to the consumer, whether another company or an individual, but providing information that is likely to commit the customer to purchase. Some conventional systems employ ranking systems (e.g. page ranking) that prioritize returned results based merely on number of “hits” to that website from previous visitors. However, such systems can be misleading as mechanized computing systems can be configured to automatically and repeatedly access such websites to “pump up” the hits count thereby making the website appear more attractive by ranking algorithms that consider only the number of hits as a metric.

Thus, users are oftentimes still forced to sift through long ordered lists of ranked documents that are not as relevant to the search intentions, needs, and goals of the user. This translates into wasted time and inconvenience for users who are searching for information. Moreover, advertising money expended for online advertising, which is in the billions of dollars per year in the United States alone, can be wasted or at least be less effective than desired.

### SUMMARY

The following presents a simplified summary in order to provide a basic understanding of some aspects of the disclosed innovation. This summary is not an extensive overview, and it is not intended to identify key/critical elements or to delineate the scope thereof Its sole purpose is to present some concepts in a simplified form as a prelude to the more detailed description that is presented later.

The disclosed architecture employs data mining of electronic messages (e.g., e-mail messages, instant messaging, . . . ) to extract information relating to relevancy and/or popularity of websites and/or web pages. Network documents or paths thereto (e.g. web pages) are often forwarded to others via embedded references or links (e.g., hyperlinks-active or inactive). By tracking user activity or interaction therewith related to, for example, the frequency of references to particular web pages as well as the frequency of forwarding links thereto, the invention can facilitate the ranking of web pages or other documents.

Accordingly, the invention disclosed and claimed herein, in one aspect thereof, comprises a computer-implemented system that facilitates ranking of web pages. A monitor component monitors information of a message for a reference to a web page or other document, and a ranking component computes rank of the web page based in part on the reference and/or user interaction associated with the reference. As previously indicated, the message can be an e-mail message, and the reference, an address to a web page. In other implementations, the message can be an SMS (Short Message Service) or MMS (Multimedia Message Service) message, for example.

In another aspect of the subject invention, the activity related to such information can be employed to raise or lower prices in connection with advertisements on such pages. Additionally, the profiles of users forwarding the e-mails can also be used to tailor the type of advertising displayed on the pages referenced in the e-mail. In another aspect, the sources of the e-mail (e.g., users, routers, mail servers, . . . ) can also be used to rank pages in connection with user demographics, preferences, locations, and profiles, for example. Information gleaned can be utilized to design novel hyperlinks or similar means for forwarding the reference link information of interest in a richer manner within the context of the message. For example, websites themselves can provide speed links and/or buttons that facilitate bulk forwarding, for example, by automatic mapping into distribution lists within an e-mail program.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates the ranking of documents such as web pages.

FIG. 2 illustrates a methodology of ranking web pages in accordance with an innovative aspect.

FIG. 3 illustrates an alternative system that facilitates web page ranking in accordance with an aspect.

FIG. 4 illustrates a methodology of tracking activity related to reference information in accordance with another aspect of the innovation.

FIG. 5 illustrates a methodology of processing user information as a means of performing document ranking in accordance with an aspect.

FIG. 6 illustrates a flow diagram of a methodology of processing messages from a predetermined source in accordance with the disclosed innovation.

FIG. 7 illustrates a system that facilitates web page ranking based on page references in e-mail messages.

FIG. 8 illustrates a flow diagram of a methodology of processing keywords and characters of a document reference in a message in accordance with an aspect.

FIG. 9 illustrates a flow diagram of a methodology of processing e-mail messages for recommender and associated recipient information for page ranking in accordance with an aspect.

FIG. 10 illustrates a flow diagram of a methodology of learning and employing popular characters and/or terms in new links to web pages.

FIG. 11 illustrates a block diagram of a computer operable to execute the disclosed web page ranking architecture.

FIG. 12 illustrates a schematic block diagram of an exemplary computing environment for message analysis and web page ranking in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The disclosed architecture employs data mining of electronic messages (e.g., e-mail messages) to extract and develop information relating to relevancy and/or popularity of websites and/or web pages. Network documents (e.g., web pages) and/or paths thereto are often attached and/or forwarded to other e-mail users via embedded references or links (e.g., hyperlinks, whether active or inactive). By tracking user activity or interaction therewith related to, for example, the frequency of references to particular web pages as well as the frequency of forwarding links thereto, the invention can facilitate the ranking of web pages or other documents.

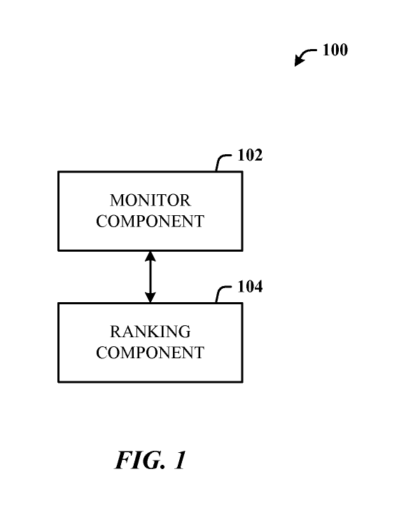

Referring initially to the drawings, FIG. 1 illustrates a computer-implemented system 100 that facilitates ranking of documents such as web pages. The system 100 includes a monitor component 102 that monitors information of a message (e.g., an e-mail message) for a reference to a web page or other document and a ranking component computes rank of the web page based in part on the reference. The monitor component 102 can be software that connects to a network and/or network entity to sample messages stored therein, whether storage is short term as in a router, or longterm as in a mail server, or to analyze and process messages passing through a system such as in a router or switch. This is described in greater detail hereinbelow.

This monitored information can include message content (e.g., text, audio, images, video, . . . ), message header information, or both, as well as any other suitable information associated with the message such as attachments (e.g., e-mail files or documents, audio files, video files, text files, . . . ), sender and distribution (or recipient) e-mail addresses, information contained in the e-mail address (e.g., aliases, IP addresses . . . ), and/or domain name information, for example. This can also include key words which can be searched in message header data, references or links contained in the message content, and/or the message content. This can further include the use of organizational relationships and/or social network information that helps to define the people who are participating in the messaging.

As previously indicated, the message can be an e-mail message and the reference information a uniform resource locator (URL) address to a web page. In other implementations, the message can be an SMS (Short Message Service) or MMS (Multimedia Message Service) message, for example, or other types of message suitable for communications in mobile wireless devices such as cellular telephones or other cellular-capable devices and systems. In still other implementations, the message can be an Instant Message (IM).

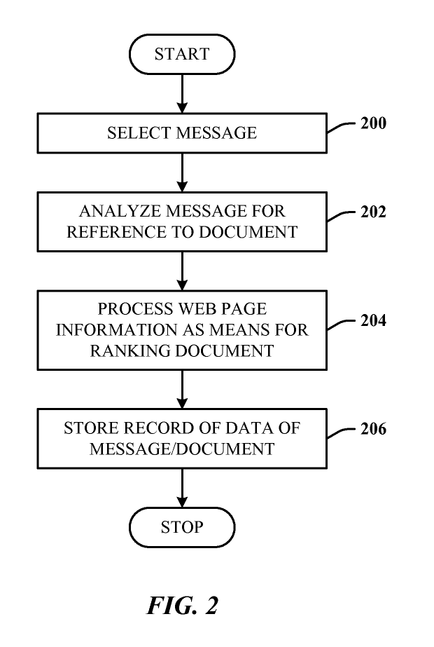

FIG. 2 illustrates a methodology of ranking web pages. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, a message (e.g., an e-mail message) is selected for analysis and processing. The message can be selected and obtained from a wide variety of sources, such as e-mail servers, routers, switches, client computers, network servers, databases, and the like. Additionally, the message can be selected based on different types of selection criteria. At 202, the message is analyzed for reference information embedded therein and/or associated therewith. The reference information can be an active hyperlink copied into the body of the message that when selected automatically launches a browser application and retrieves the associated document (e.g., web page) for presentation to the user. Alternatively, the hyperlink can be inactive such that the user needs to copy the reference information into the browser for execution and retrieval of the associated web document. In any case, the reference information includes data that can be analyzed to determine the document in which the user is interested.

At 204, the reference information is extracted and processed to rank the associated document (e.g., web page). The ranking process can be associated with a search engine that returns web pages in a ranked format for review and selection by a user. In other implementations, the ranking is performed automatically as a background function or system process for ascertaining other pertinent information. For example, web page advertising is big business. Accordingly, mechanisms for determining value of web page real estate are continually evolving. As described herein, by analyzing user activity (e.g., selection, forwarding, . . . ) related to message information, and specifically, to embedded links to web pages, the value of advertising space on that web page can be determined. For example, as the user interaction increases for that web page, its associated ranking will likely increase thereby driving up the prices for advertisements posted on that page.

In one implementation of 204, the ranking document process can use a modified version of a conventional document ranking technology (e.g., Page Rank) or other similar techniques. In these techniques, there is some visit probability associated with each page. The rank of a page depends on the rank of the pages that link to it, which in turn depends on the rank of the pages that link to them, etc. Such scores can be computed recursively. Such methods typically have either or both of an initial vector with initial ranks for pages, or a jump vector, with a probability of visiting a page completely at random, rather than based on the ranks of other pages. Either of these two vectors can be based at least in part on links in e-mail or other messages. This can bias the ranking towards pages that are more commonly visited, as well as to the pages they link to, etc.

In yet another implementation of 204, a machine learning component ranks the pages, and information about the links from messages is one component of the ranking.

At 206, information related to the message can be stored for later analysis and processing. For example, in one implementation, the analysis and processing is performed in realtime as the message is selected for processing. In another implementation, messages having the associated reference information are selected and stored for later processing and analysis. In still another application, both realtime processing and subsequent storage processing are provided.

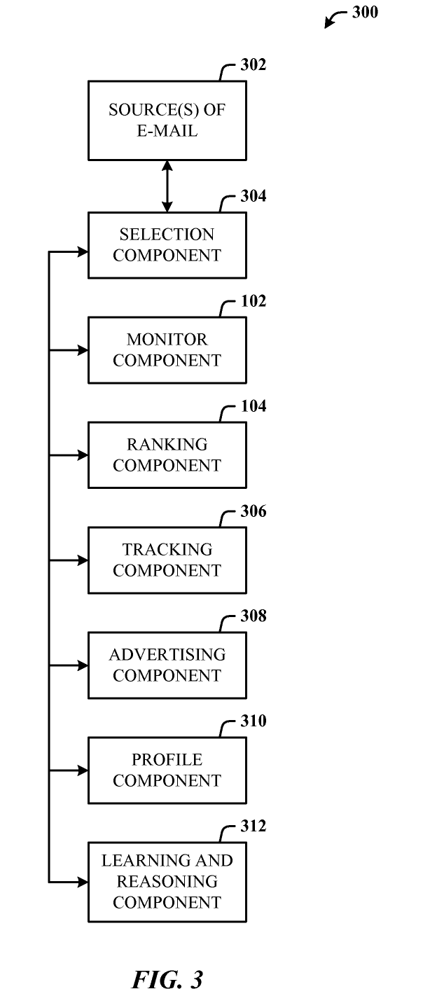

Referring now to FIG. 3, there is illustrated an alternative system 300 that facilitates web page ranking. The system 300 includes both the monitor component 102 and the ranking component 104 of FIG. 1 that facilitate the analysis and processing of e-mail from one or more e-mail sources 302. Note that although subsequent discussion focuses on e-mail, it is to be understood that the description applies equally to other types of messages that can embody references to web pages or other documents.

Additionally, the system 300 can include a selection component 304 for selecting e-mail from the one or more e-mail sources 302. Selection can be based on many different types and/or combinations of selection information. For example, selection information can restrict the messages to be processed only to e-mail messages. Another selection filter can be in the format of a rule that when executed only selects e-mail from User A and only at times ranging from 6 PM to 6 AM. Still another example rule filter only selects e-mail from an enterprise network of a company, or a subnet thereof. Yet other selection methodologies may try to avoid mail that might be spam, such as mail detected as spam by an automated filter, or mail from users not on the recipient's safe sender list. Thus, selection can be rules-based, as well as for any other system entity described herein. In another example, the e-mail is sampled from a network switch, rather than a network e-mail server.

Selection can also include, but is not limited to, accessing e-mail attachments (e.g. other e-mails, documents, . . . ) for analysis of included reference information. It is to be understood that an attached document (that is not an e-mail message) can also include one or more embedded reference links (e.g., hyperlinks). For example, an attached spreadsheet document can include an embedded hyperlink to a web page or other network document. Accordingly, this information can also be considered in ranking documents and/or web pages.

The system 300 can also employ a tracking component 306 for tracking desired parameters, properties, activities, attributes, etc., of the system 300, and of network-based entities not shown (e.g., user activity while in a browser of the user client). In one implementation, the tracking component 306 logs user interaction when the user receives and transmits an e-mail message having a web page link or reference in the body of the message. For example, the system 300 can simply monitor presence (or absence) of embedded reference information. The system 300 can further monitor and record if the user selects the reference link (also referred to a click-through process), as well as how often the user will select the embedded reference information for viewing (the frequency of viewing) can also be recorded and processed. Still further, the system 300 can track how often e-mail with the embedded reference link is forwarded (the frequency of forwarding) and to how many other users are on the distribution list. The click-through rate and frequency can also be analyzed on a multi-user basis to compute the frequencies and/or click-through rates over many thousands or millions of users and messages, for example, which further provides some measure of valuation for the ranking the web page and for page real estate in terms of advertising.

The system 300 can also include an advertising component 308 that operates process advertising associated with web pages or other viewer perceived content. For example, the advertising component 308 can provide continual valuations of web page advertising space based on web page rankings. Accordingly, advertisers can be charged in near realtime for ad space based on continually changing web page rankings. In another implementation, the value of the ad space is locked in for a multi-day period based on predefined fixed valuation time period of perhaps a couple hours of a certain day for performing the valuation process. Many other forms for determining the value of ad space can be employed in accordance with the subject invention, and the implementations described herein are not to be construed as limiting in any way. For example, the valuation can be based on the frequencies (forwarding and viewing) mentioned above, as well as the click-through rates, rather than web page ranking.

A profile component 310 facilitates including at least user profile information as part of the computations for selecting e-mail sources, selecting e-mail messages, ranking of web pages, ranking other documents, and advertising valuation, for example. The user profiles can be processed to affect not only what web page to be presented in the rankings, but also the type of advertisements that are presented to the user once the referenced web page is retrieved and presented.

This flexibility can also apply to a device profile (or device specifications) such that if the device is a handheld mobile device with a small display, there is a limited viewing area in which to present advertisements. Accordingly, based not only on the device profile, but also on the user profile information, the available advertisements can be filtered to present only ads preferred by the user and that will be presentable on the user device. This can also affect the value of the advertisement as presented to that user. In such implementations, the granularity with which advertisers can be charged drops down to the user level; in other words, one-on-one, rather than broadcasting a generalized ad to large numbers of viewers. The advertising is then more focused to that specific user, providing an enormous benefit for advertisers to target consumers according to their own goals, intentions, needs, context, and so on.

The system 300 can also include a machine learning and reasoning (MLR) component 312 which facilitates automating one or more features in accordance with the subject innovation. Various MLR-based schemes for carrying out aspects of the invention can be employed. For example, a process for determining which messages to select can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g. via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one example, the MLR component 312 monitors the sampling of e-mails from a network or subnet to learn and reason about patterns of user activity with respect to embedded reference information. In another example, learning and reasoning can be applied to information gleaned from the user system. For example, the MLR component 312 can access e-mail and/or IM messages for web reference information (e.g., hyperlinks) from which it can be inferred that the user has an interest. This can be weighted more heavily on the messages being sent or that had been sent, since it can be inferred that the user adopts the link by sending it to another. Messages that have been received could be given less weight since these messages could have been received as spam, and then deleted. However, as indicated herein, user interaction can also be tracked as a means for inferring user intentions and goals.

In yet another example, based on user interaction (or lack thereof) with embedded links, the MLR component 312 facilitates learning and reasoning about changes in user interest, intentions, needs, and goals over time, thereby affecting changes in web page rankings, for example, based on such changes. These are only but a few examples of the capabilities provided by the MLR component 312, and are not to be construed as limiting in any way. The MLR component 312 may be used on a per-user or global basis. For instance, the search system may be a personalized search system that adapts to the user. This adaptation may be based at least in part on the URLs received by or clicked on by the user in messages. In yet another implementation, the MLR system is used globally to affect the ranking for all users. And in yet still another implementation, intermediate granularities are used, for example, affecting the ranking for an organization or group.

In another aspect, machine learning can be employed to handle link spam. Link spam is a problem of bad web pages receiving good ranking in a search. Machine learning and reasoning can be utilized to learn and reason about the likelihood that a domain uses link spam to boost its rank, the likelihood that that a link is link spam, and/or the likelihood that a URL uses link spam to boost its rank, for example.

Machine learning algorithms have a set of inputs, and produce an output (typically a probability). They are trained up using “training data” and then can be run on test data. For example, 500 examples of pages using link spam and 500 examples of pages not using link spam can be found. For each of these 1000 pages, the system is given a set of inputs. For instance, inputs such as the ratio of the number of domain names that link to this domain name divided by the number of distinct IP addresses that have a link to this domain name can be used. Large samples of good messages (e.g., e-mail or IM messages) can be obtained from known good sources such as spam message databases.

Link spammers presumably have many domain names sharing an IP address, while for legitimate people the ratio should approximate one. Similar ratios can be employed, such as the number of domain names that link to this domain name, divided by the number of distinct DNS (domain name server) servers that host a site that links to this domain name. Training data can be provided manually, by finding a large number of sites that use link spamming, and a large number of sites that do not, and hand categorizing them. The manner in which these sites are found can be useful. For example, the sites should include successful link spammers. Moreover, the sites should include a variety of different kinds of link spammers.

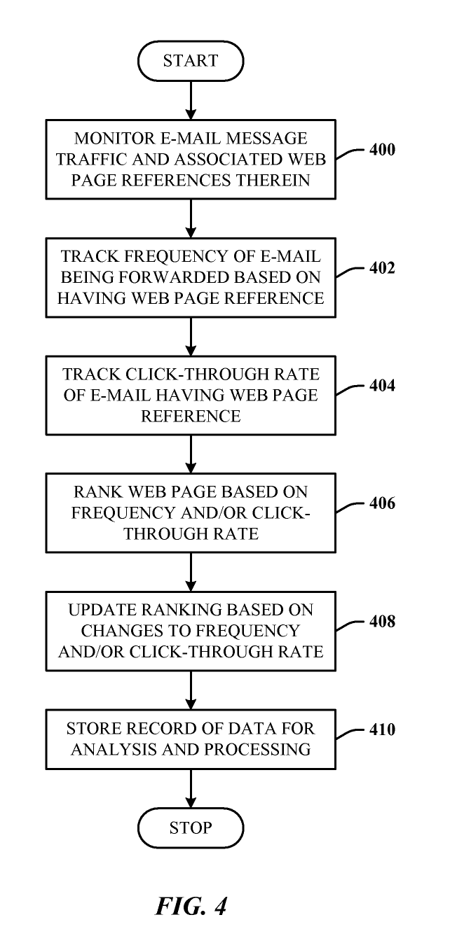

FIG. 4 illustrates a methodology of tracking activity related to reference information in accordance with another aspect of the innovation. At 400, the system monitors e-mail message traffic at any number of different sources. At 402, the frequency at which a user forwards an e-mail having a specific embedded reference is tracked. Other data tracked can include the frequency at which a user forwards any e-mail containing a web page reference. At 404, the click-through rate of a link can be tracked. In other words, the fact that the link was executed provides some measure of value to the web page of that link. Additionally, the click-though rate for a given user presented with an e-mail having the reference information can be tracked.

At 406, the frequency data and/or the click-through data can be processed for ranking the web page among other web pages. The ranking can be for the sole purpose of presenting relevant content for that user, as well as for popularity of the content for other users. In other words, some or all information tracked, recorded, analyzed and processed can be for the sole benefit of a single user, based only on the interactions of that user to embedded e-mail references, user profiles, device profiles, and so on. Accordingly, each user will see web page rankings customized to their own inferred needs, intentions, goals, etc. At 408, the ranking can be changed based on changes in multiple user patterns, shifts in content, and so on. Specifically, if the frequency data and/or click-through data change, the corresponding ranking of a web page can change. At 410, some or all of this data is stored for offline processing, for example, to obtain data by data mining techniques related to other aspects deemed potentially important in page ranking, modifying user profiles and device profiles, determining user buying habits, interests, goals, and needs.

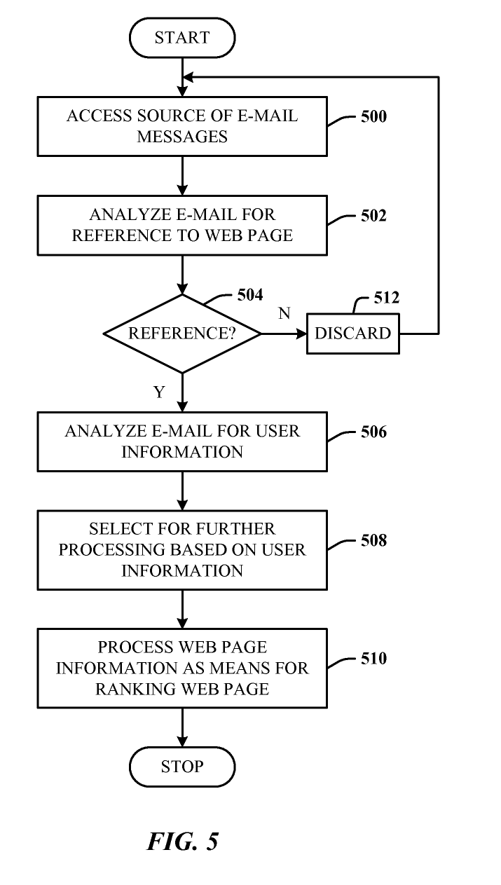

FIG. 5 illustrates a methodology of processing user information as a means of performing document ranking in accordance with an aspect. At 500, one or more sources of e-mails are accessed. At 502, the selected e-mail is analyzed for web page references. The references can be in the form of active hyperlinks or inactive hyperlinks that the user copies into a browser and executes. Such copy-and-execute activity can also be monitored as a means of confirming that the user would have executed an active hyperlink had it been available in the message. This can also be utilized for ranking web pages or other referenced documents. In another example where the user is presented with an embedded inactive link to a web page, causes the inactive link to become active, and executes the now active link, this can also be considered for ranking the referenced web page.

At 504, a check is made to determine if the e-mail includes a link to a document or web page. That is, if the e-mail does not contain embedded reference information, it may be desirable to simply discard (or ignore) the e-mail for purposes of document ranking, since interest is only in e-mail having reference information. If so, at 506, the system analyzes the e-mail for user information. This information can be obtained from header information, for example, and/or from the body of the message. For example, in many cases, a user will reply with header information in the body of the reply message, this header information (e.g., the recipient name or address or distribution list, the sender, the subject, . . . ) forming part of a thread of information that many users prefer to keep to provide history of the subject. At 508, if the message includes the desired user information further processing is performed. At 510, the included web page information is processed as one means for ranking the referenced web page. Alternatively, at 504, if the e-mail message does not include any referencing information, it can be discarded (or ignored), as indicated at 512. Flow can then be back to 500 to select another message for processing.

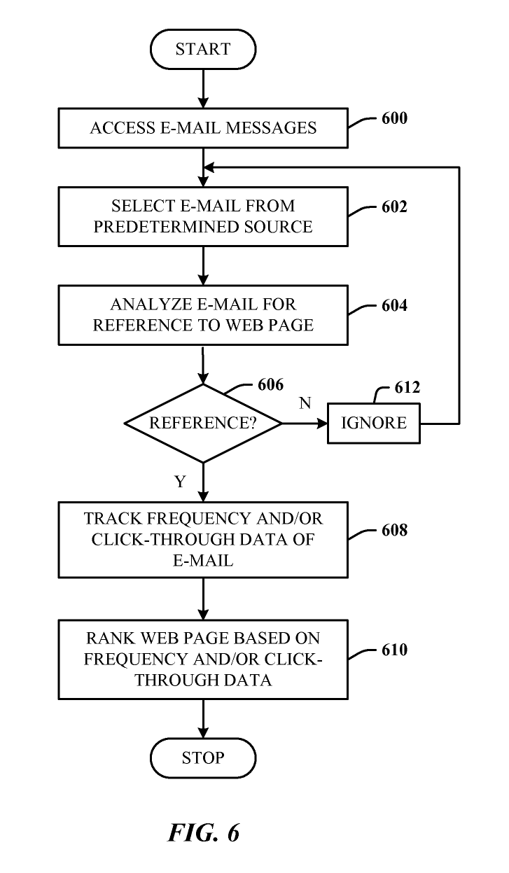

Referring now to FIG. 6, there is illustrated a flow diagram of a methodology of processing messages from a predetermined source in accordance with the disclosed innovation. At 600, e-mail messages are accessed from many different sources (e.g., network entities, users . . . ). At 602, the messages are analyzed for source information of a predetermined source. Once selected, the messages are analyzed for reference information embedded therein, as indicated at 604. At 606, the system checks if the message contains a reference. If so, at 608, the system monitors user interaction with the message and/or its reference information by tracking the frequency information and/or click-through data. At 610, the corresponding web page can then be ranked based at least on the frequency information and/or the click-through data. As before, if, at 606, the e-mail does not include reference information, it can be ignored, as indicated at 612, and the next message selected for source information, at 602.

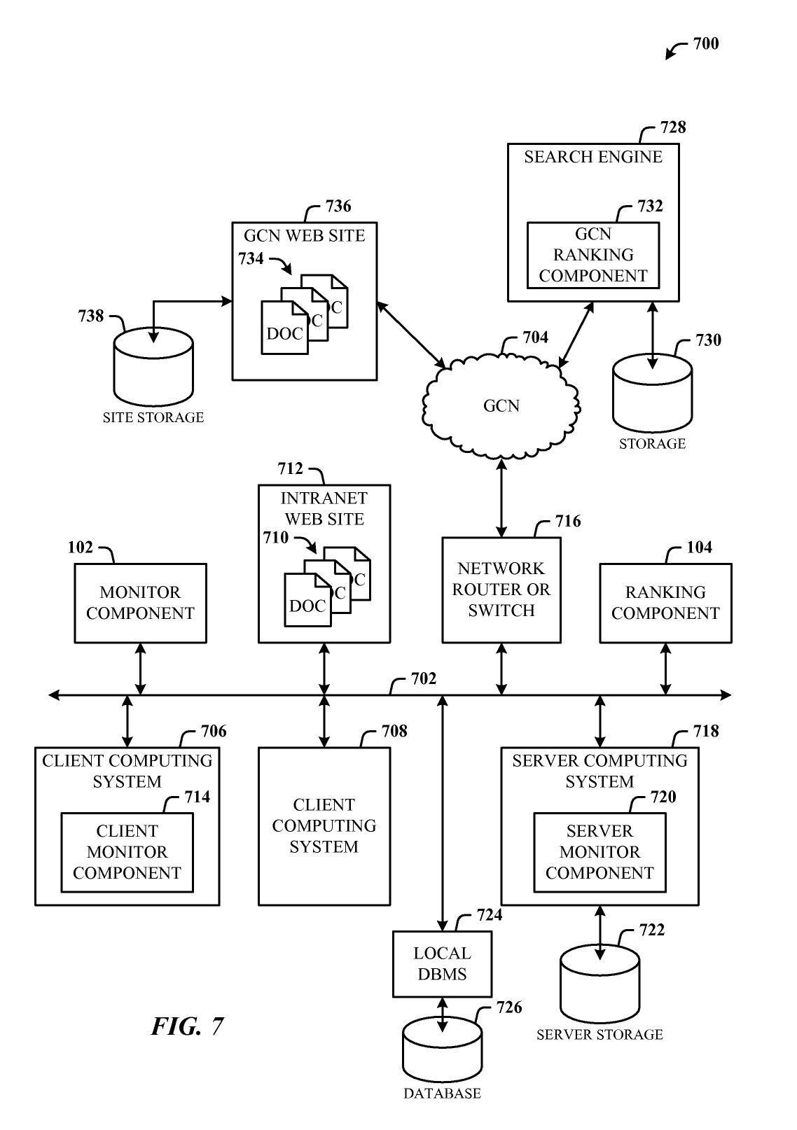

FIG. 7 illustrates a system 700 that facilitates web page ranking based on page references in e-mail messages. Page rank processing can occur in a small scale environment such as for a local network (or intranet) 702, and/or on a larger scale that utilizes a global communications network (GCN) 704 (e.g., the Internet). On a local level, the local network 702 can include the monitor component 102 disposed thereon for monitoring messages (e.g., e-mail) sent across the network 702 and/or made accessible by storage (e.g., longterm or temporary) on any network entities. For example, the monitor component 102 can access and analyze e-mail messages stored on a first client computing system 706 and a second client computing system 708 for web page links to web pages 710 hosted on an intranet web site server 712. Based on at least frequency information and click-through information, the web pages 710 can be ranked as results of a search conducted by the user of the first client system 706, for example.

Alternatively, the monitor component 102 can be configured as a client monitor application (or agent) 714 of the first client system 706 such that the client monitor application 714 operates to analyze and process messages containing page and/or document reference information for the local network 702 and/or of the first client computing system 706. Thus, e-mail messages communicated by the second computing system 708 can also be analyzed and processed by the client component 714.

In yet another implementation, both the monitor component 102 and the client monitor component 714 function and interface together in that the client component 714 communicates message information to the local network-based monitor component 102.

In that large amounts of data are communicated over networks and through routers, bridges, gateways, switches, etc., the monitor component 102 can be configured to access message traffic in a network routing device such as a router or switch 716, and pull copies of the messages for analysis and processing for embedded reference information and/or attachments having the enclosed reference link information. Results can then be communicated to the ranking component 104, which here, is local to the network 702, for ranking of the web pages or documents.

The local network 702 can also include a server computing system 718 that can serve at least as a search engine, and to which the monitor information (from the monitor component 102 and/or client monitor component 714) can be transmitted thereto for ranking purposes. Once ranked, the search engine service can return the ranked web pages to the first client system 706 for presentation to the client user.

In still another example embodiment, the server 718 disposed on the local network 702 hosts a monitor service 720 that executes to perform monitor functions described herein at least with respect to the monitor component 102 and the client monitor 714. For example, the server 718 can be a mail server that receives and distributes e-mail messages between the local clients (706 and 708) as well as between networks and entities remote from the local network 702 (e.g., the GCN 704). A server storage 722 of the server system 718 facilitates the storage of related server information, including messages, messages having embedded document links, user profiles, device profiles, and any other information.

Similarly, the local network 702 can include a local database management system (DBMS) 724 and associated database 726 for the storage of some of the same information as the server system 718, hierarchical data, object data, etc. The DBMS 724 can also provide remote storage for the local clients (706 and 708), as well as other network entities.

As illustrated, the local network 702 and local entities (102, 104, 706, 708, 712, 718, and 724) can access entities or be accessed by entities connected to the GCN 704. Here, a search engine 728 and associated storage system 730 facilitate searches by users of the GCN 704 as well as the local entities (e.g., the local clients 706 and 708). The search engine 728 can also host a GCN ranking component 732 for ranking search results for requesting queries. The ranking component 732 can be in addition to the local ranking component 104, for example.

The local ranking component 104 can cooperate with the local monitor component 102 to process e-mail messages (and attachments) of the local network 702 that reference GCN web pages (or documents) 734 of a GCN website 736 disposed on the GCN 704, and stored in a site storage 738.

It is to be understood that although not shown, other components of FIG. 3 (e.g., the selection component 304, tracking component 306, advertising component 308, profile component 310, and MLR component 312) can be disposed on the local and/or remote networks (702 and 704). Moreover, as described, network access by local and remote network entities facilitates the monitoring and ranking of documents and web pages across many different networks, network routing systems, local and remote web sites, etc. Thus, the components (304, 306, 308, 310, and 312) of FIG. 3 can access information from any one or more of the networks and network entities. Sources of the e-mail or IM (or other types of messages) can also be used to rank web pages in connection with user demographics, preferences, locations, and profiles.

Additionally, the information gleaned from the invention can be used to design novel hyperlinks or means for forwarding the web page information of interest in a richer manner within the context of e-mail message. Further, websites themselves can provide speed links or buttons that facilitate bulk forwarding of information by mapping the information into distribution lists within the e-mail program.

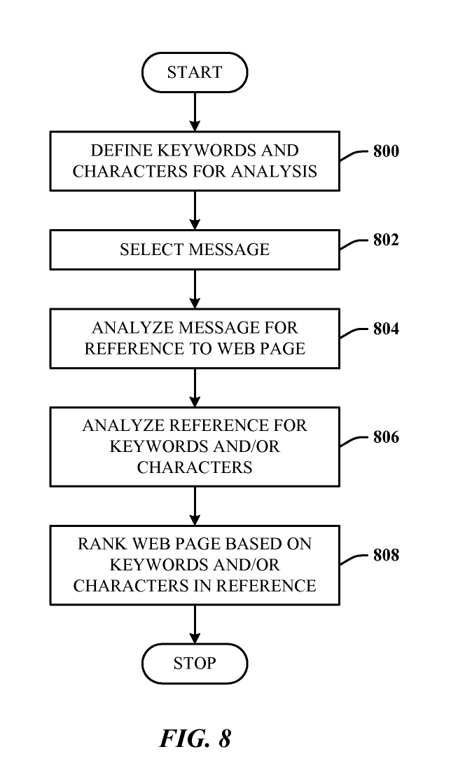

FIG. 8 illustrates a flow diagram of a methodology of processing keywords and characters of a document reference in a message in accordance with an aspect. At 800, keywords and/or characters are defined for analysis. At 802, a message is selected. The message is then analyzed for reference link information for a web page, as indicated at 804. At 806, the reference is analyzed for keywords and/or characters. At 808, web pages are ranked based on the keywords and/or characters.

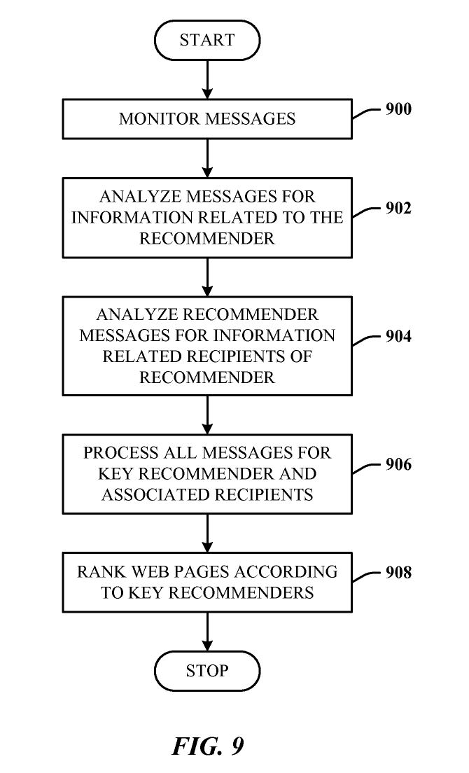

FIG. 9 illustrates a flow diagram of a methodology of processing e-mail messages for recommender and associated recipient information for page ranking in accordance with an aspect. At 900, e-mail messages are monitored. At 902, the many messages are analyzed for information related to the recommender (or user who sends the message). This can be user information or device information, for example. At 904, the recommender messages are further analyzed for recipient information such as distribution lists, for example. At 906, all messages are further processed to determine a key recommender and his or her associated recipients. At 908, web pages are then ranked based on the key recommenders. Moreover, networks (e.g., subnets) can be ranked based on the number of key recommenders on given networks. Web pages hosted on these key networks can then be further ranked accordingly based on the key network information.

It is to be understood that the recommender can be a high level company employee, of which such information can further be employed in ranking the web pages. That is, reference links executed or forwarded by such a priority recommender can be weighted more heavily during the ranking process, such that another user searching or executing the reference link will be presented with similar types of page content or hits.

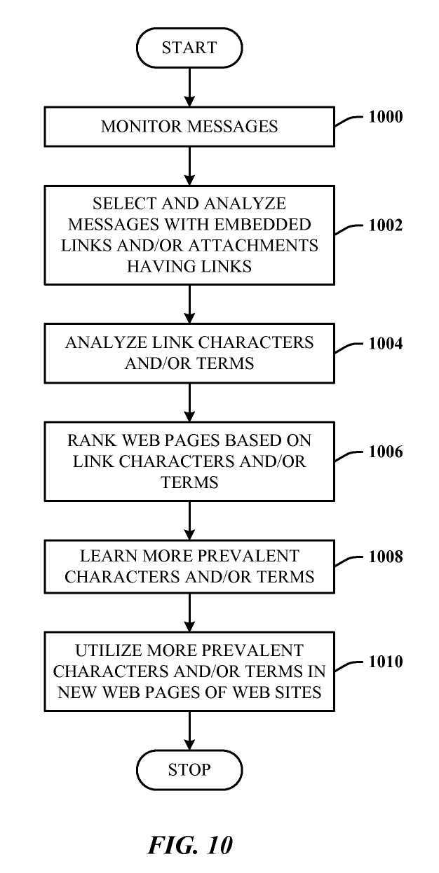

FIG. 10 illustrates a flow diagram of a methodology of learning and employing popular characters and/or terms in new links to web pages. At 1000, a plurality of messages is monitored. At 1002, messages that include embedded links and/or include attachments that contain links, are selected and analyzed. At 1004, link characters and/or terms are analyzed. At 1006, web pages are then ranked based on the link characters and/or terms. At 1008, the more prevalent characters and/or terms are learned. The more prevalent information is then rolled back into links to new web pages or web sites, as indicated at 1010.

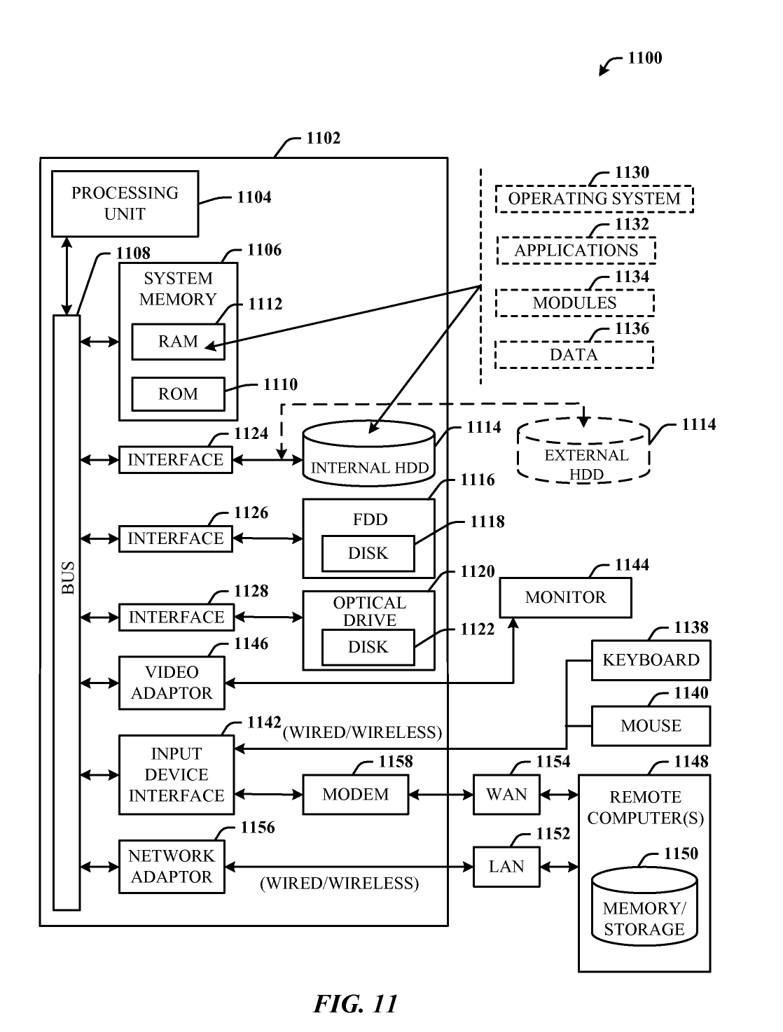

Referring now to FIG. 11, there is illustrated a block diagram of a computer operable to execute the disclosed web page ranking architecture. In order to provide additional context for various aspects thereof, FIG. 11 and the following discussion are intended to provide a brief, general description of a suitable computing environment 1100 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g. a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

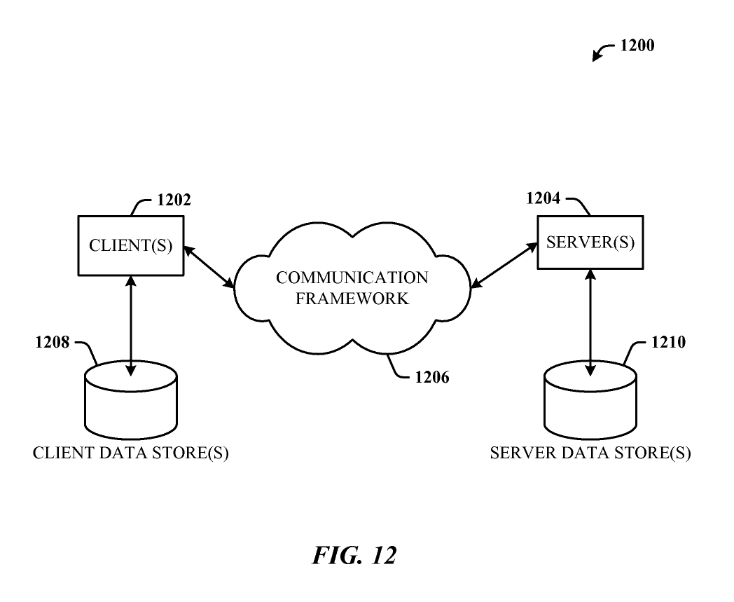

Referring now to FIG. 12, there is illustrated a schematic block diagram of an exemplary computing environment 1200 for message analysis and web page ranking in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the subject innovation, for example.

The system 1200 also includes one or more server(s) 1204. The server(s) 1204 can also be hardware and/or software (e.g., threads, processes, computing devices). The servers 1204 can house threads to perform transformations by employing the invention, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates ranking of web pages, comprising:
a monitor component that monitors information of a message for reference to a web page; and
a ranking component that computes rank of the web page based in part on the message reference.

2. The system of claim 1, wherein the message is one of an e-mail message and an instant message, and the reference the monitoring component identifies is an address to a web page.

3. The system of claim 1, wherein the monitor component analyzes message header information and message content.

4. The system of claim 1, wherein the monitor component extracts information related to relevancy and popularity of the web page.

5. The system of claim 4, wherein the popularity of the web page is utilized by a machine learning system to affect the rank of the page.

6. The system of claim 1, further comprising a selection component that selects messages based on at least one of message source information, message destination information, output of a spam filter, and sender presence on a safe sender list.

7. The system of claim 1, further comprising a tracking component that tracks frequency information related to how often the web page reference is forwarded.

8. The system of claim 1, further comprising a tracking component that tracks click-through information related to how often the web page reference is selected.

9. The system of claim 1, further comprising an advertising component that modifies value set for an advertisement based in part on user interaction with the message having the reference.

10. The system of claim 9, wherein the advertisement is displayed as part of the web page associated with the reference.

11. The system of claim 1, further comprising a profile component that generates a profile of a network based on user interaction with the message.

12. A computer-implemented method of ranking web pages, comprising:
monitoring at least one of e-mail and IM messages having web page reference information contained therein;
tracking frequency at which the messages are forwarded based on the web page reference information; and
ranking of the web page reference information as a function of the frequency of at which the e-mail messages are forwarded.

13. The method of claim 12, further comprising tracking click-through rate of the web page reference information within the respective messages.

14. The method of claim 12, further comprising re-ranking the web page reference information based on change in frequency at which the e-mail messages are forwarded.

15. The method of claim 12, further comprising analyzing the reference information for key information, and performing ranking based additionally thereon.

16. The method of claim 12, further comprising;
determining user information associated with the messages; and
identifying a user related to the user information as a priority source of the e-mail messages.

17. The method of claim 12, further comprising analyzing an attachment of the e-mail message for web page reference information.

18. The method of claim 12, further comprising processing the web page reference information of one or more of the e-mail messages to infer intent of a user associated with the one or more of the e-mail messages.

19. A computer-executable system of ranking web information, comprising:
computer-implemented means for selecting e-mail messages having embedded network document linking information;
computer-implemented means for tracking user interaction with the network document linking information; and
computer-implemented means for ranking a web page based on user interaction data related to the user interaction with the network document linking information.

20. The system of claim 19, wherein the network document linking information automatically routes the user to a corresponding network document when the user interaction is a selection action.
